(19) United States
(12) Patent Application Publication
(10) Pub. No.: US 2015/0003819 A1
(43) Pub. Date: Jan. 1, 2015

(54) CAMERA AUTO-FOCUS BASED ON EYE GAZE

(71) Applicants: Nathan Ackerman, Seattle, WA (US); Andrew C. Goris, Loveland, CO (US); Bruno Silva, Clyde Hill, WA (US)

(72) Inventors: Nathan Ackerman, Seattle, WA (US); Andrew C. Goris, Loveland, CO (US); Bruno Silva, Clyde Hill, WA (US)

(21) Appl. No.: 13/931,527

(22) Filed: Jun. 28, 2013

(51) Int. Cl. G03B 13/02

(52) U.S. Cl. CPC G03B 13/02
USPC 396/51

(57) ABSTRACT

Technology disclosed herein automatically focus a camera based on eye tracking. Techniques include tracking an eye gaze of eyes to determine a location at which the user is focusing. Then, a camera lens may be focused on that location. In one aspect, a first vector that corresponds to a first direction in which a first eye of a user is gazing at a point in time is determined. A second vector that corresponds to a second direction in which a second eye of the user is gazing at the point in time is determined. A location of an intersection of the first vector and the second vector is determined. A distance between the location of intersection and a location of a lens of the camera is determined. The lens is focused based on the distance. The lens could be focused based on a single eye vector and a depth image.

### BACKGROUND

One of the biggest problems with cameras in consumer electronic devices is the time between the user wanting to capture an image (e.g., photo or video) and the time at which the image is actually captured. Techniques for automatically focusing cameras help to relieve the burden on the user of having to manually focus the camera. However, autofocus algorithms can take time to perform. Also, the algorithm may mistakenly focus the camera on the wrong object.

One technique for autofocus is for the camera to sweep through a range of focal distances, collecting image data at each of a number of distances. The image data is then analyzed using image processing to determine which image provided the best focus. The camera then takes a picture at this best focal distance. A problem with such a technique is the time that it takes the camera to sweep through the different focal distances.

Another technique is to select an object in the field of view of the camera. The camera can then be automatically focused for that object. Some cameras can detect faces and automatically focus on a face. However, it can be difficult to know what object that the camera should focus on, as it can be difficult to know what object the user wishes to take a picture of. For example, there may be a person in the foreground and a tree in the background. If the camera system incorrectly assumes that the user desires to take a picture of the person in the foreground, then the tree would be out of focus. Of course, the camera can be re-focused on the tree, but this takes additional time. If the user was attempting to take a picture of a bird in the tree, the bird may have flown by the time the camera is focused.

### SUMMARY

Methods and systems for automatically focusing a camera are disclosed. Techniques include tracking an eye gaze of eyes to determine a location at which the user is focusing. Then, a camera lens may be focused on that location. This allows for fast focusing of the camera.

One embodiment includes a method for automatically focusing a camera including the following. An eye gaze of a user is tracking using an eye tracking system. A vector that corresponds to a direction in which an eye of a user is gazing at a point in time is determined based on the eye tracking. The direction is in a field of view of a camera. A distance is determined based on the vector and a location of a lens of the camera. The lens is automatically focused based on the distance.

One embodiment includes a system comprising a camera having a lens and logic coupled to the camera. The logic is configured to perform the following. The logic is configured to determine a first vector that corresponds to a first direction in which a first eye of a user is gazing at a point in time. The logic is configured to determine a second vector that corresponds to a second direction in which a second eye of the user is gazing at the point in time. The logic is configured to determine a location of an intersection of the first vector and the second vector. The logic is configured to determine a distance between the location of intersection and a location of the lens. The logic is configured to focus the lens based on the distance.

One embodiment includes a method for automatically focusing a camera including the following. A user's eyes are tracking using an eye tracking system. A plurality of first vectors that each correspond to a first direction in which a first eye of a user is gazing at different points in time are determined based on the eye tracking. A plurality of second vectors that each correspond to a second direction in which a second eye of the user is gazing at corresponding ones of the different points in time are determined based on the eye tracking. A plurality of intersections of the first vectors and the second vectors for each of the different points in time are determined A depth map is generated based on locations of the plurality of intersections. A lens of a camera is automatically focused based on the depth map.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

FIG. 1A and FIG. 1B illustrate an example of focusing a camera based on tracking the direction of a person's eye gaze.

FIG. 2A is a flowchart of one embodiment of a process of auto-focusing a camera.

FIG. 2B is a flowchart of one embodiment of a process of auto-focusing a camera using a point of intersection of two eye vectors.

FIG. 2C is a diagram to help illustrate principles of one embodiment of calculating a location of eye gaze.

FIG. 2D is a flowchart of auto-focusing a camera using an eye vector and a depth image.

FIG. 3A is a block diagram depicting example components of one embodiment of a HMD device.

FIG. 3B depicts a top view of a portion of HMD device.

FIG. 3C illustrates an exemplary arrangement of positions of respective sets of gaze detection elements in a gaze detection system for each eye positioned facing each respective eye on a mixed reality display device embodied in a set of eyeglasses.

FIG. 3D illustrates another exemplary arrangement of positions of respective sets of gaze detection elements in a gaze detection system for each eye positioned facing each respective eye on a mixed reality display device embodied in a set of eyeglasses.

FIG. 3E illustrates yet another exemplary arrangement of positions of respective sets of gaze detection elements in a gaze detection system for each eye positioned facing each respective eye by the set of eyeglasses.

FIG. 4 is a block diagram depicting various components of an HMD device.

FIG. 5 is a block diagram of one embodiment of the components of a processing unit of an HMD device.

FIG. 6 is a flowchart of one embodiment of a process of focusing a camera based on a depth map of locations gazed at by a user.

FIG. 7 is a flowchart of one embodiment of a process for automatically focusing a camera.

FIG. 8A is flowchart of one embodiment of a process of autofocusing a camera based on eye tracking in which the camera selects a face to focus upon.

FIG. 8B is flowchart of one embodiment of a process of autofocusing a camera based on eye tracking in which the camera selects the center of the camera's field of view (FOV) to focus upon.

FIG. 8C is flowchart of one embodiment of a process of autofocusing a camera based on eye tracking in which the user manually selects an object to focus upon.

FIG. 9A is one embodiment of a flowchart of focusing a camera based on the last location that a user gazed at.

FIG. 9B is one embodiment of a flowchart of focusing a camera based on two or more location at which a user recently gazed.

FIG. 10A is a flowchart of one embodiment of a process of camera autofocus based on an amount of time a user spent gazing at various locations.

FIG. 10B is a flowchart of one embodiment of a process of camera autofocus based on weighting an amount of time a user spent gazing at various locations.

FIG. 11 is a flowchart describing one embodiment for tracking an eye using the technology described above.

### DETAILED DESCRIPTION

Methods and systems for automatically focusing a camera are disclosed. In one embodiment, the system tracks an eye gaze of two eyes to determine a point at which the user is focusing. This location is determined as the intersection of two vectors, each corresponding to the direction in which one of the eyes is gazing, in one embodiment. Then, a camera lens may be focused at that point. In one embodiment, the system tracks an eye gaze of the user, accesses a depth image having depth values, and determines a point in the depth image that corresponds to the vector. This point could be an object that the user is gazing at. From the depth values and a known position of the camera, the system is able to determine a distance from a camera to the object. The term “gaze” refers to a user looking in some direction for some minimum time. There is no set minimum time, as this is a parameter that can be adjusted.

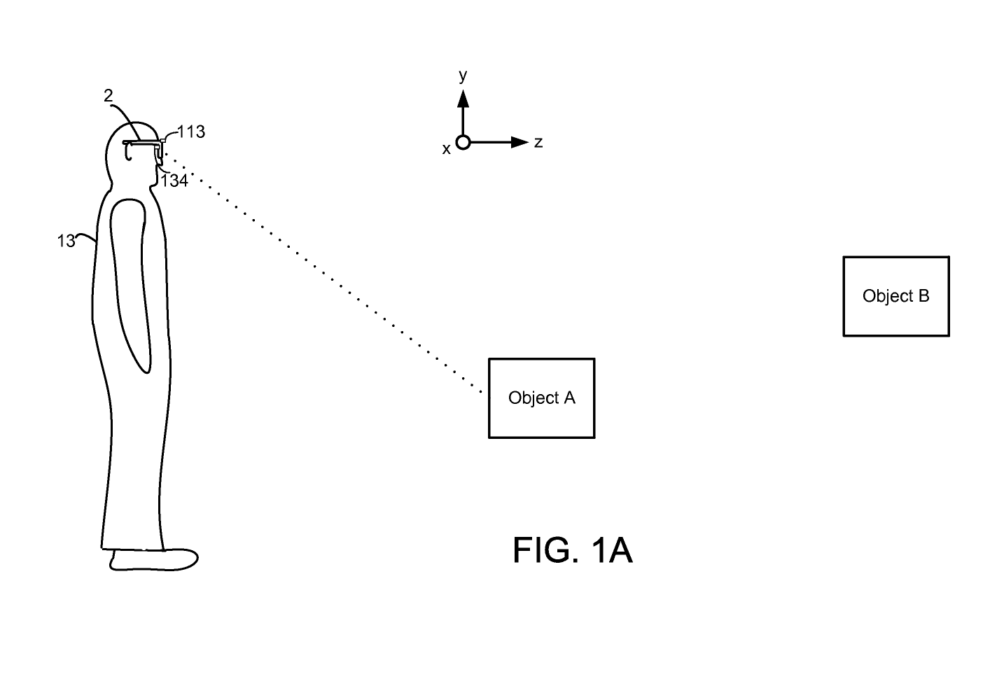

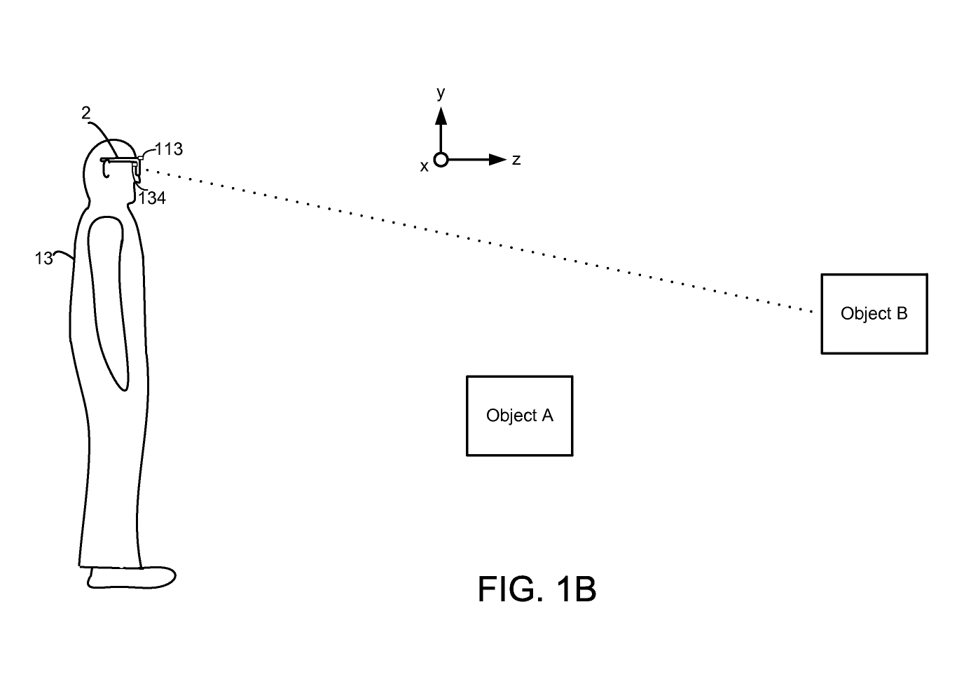

FIGS. 1A and 1B illustrate an example of focusing a camera based on tracking the direction of a person's eye gaze. In this example, the person 13 is wearing a device 2 that includes both a camera 113 and eye tracking sensors 134. However, the camera 113 could be separate device from the device having the eye tracking sensors 134. In FIG. 1A, the person 13 is gazing at Object A. The device 2 tracks the user's eye gaze to determine that the user 13 is looking at something at that location. The device 2 does not need to know that there is an object at that location. Rather, the device 2 simply determines a 3D coordinate for that location in some reference coordinate system, in one embodiment. The device 2 then focuses the camera 113 so that it is properly focused to capture an image of Object A. This can be achieved by knowing the camera's location in the coordinate system and determining the distance between the camera lens and the point at which the user is gazing. Then, the device 2 focuses the camera 113 for that distance. Note that the camera 113 could take still images (e.g. pictures) or moving images (e.g., video).

In FIG. 1B, the person 13 is gazing at Object B. The device 2 tracks the user's eye gaze to determine that the user 13 is looking at something at that location. The device 2 then focuses the camera 113 so that it is properly focused to capture an image of Object B. As noted above, the device 2 need not know that there is anything where Object B is located. The device 2 can simply determine the distance between the camera 113 and the location at which the user is gazing, and then properly focus the camera 113 for that distance.

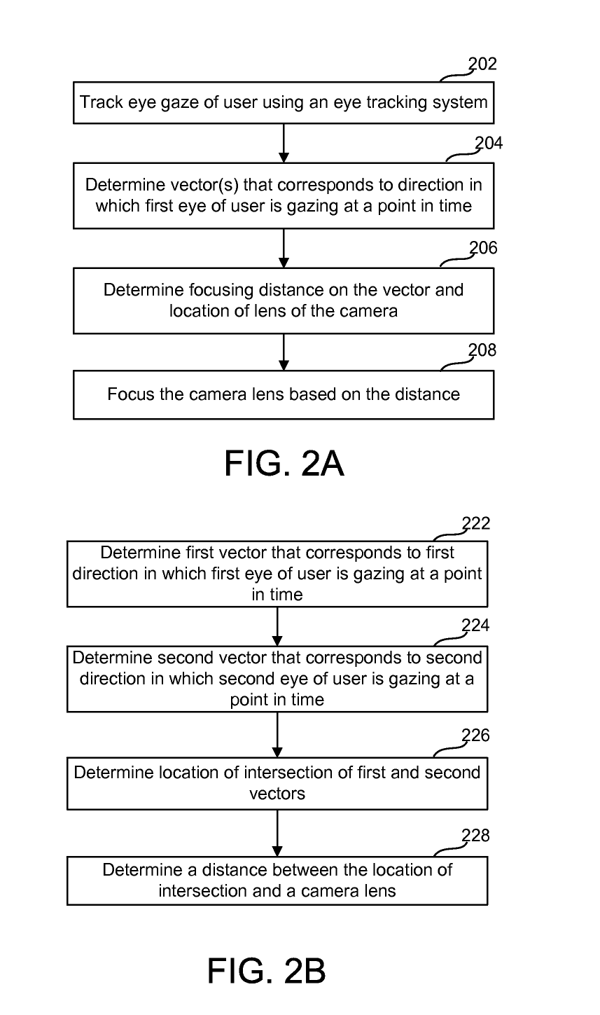

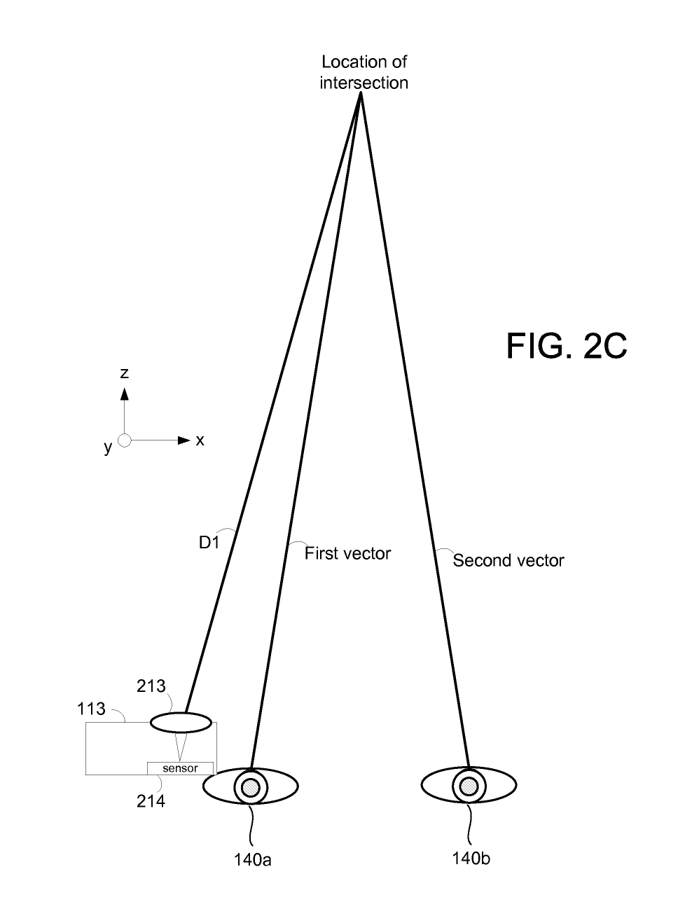

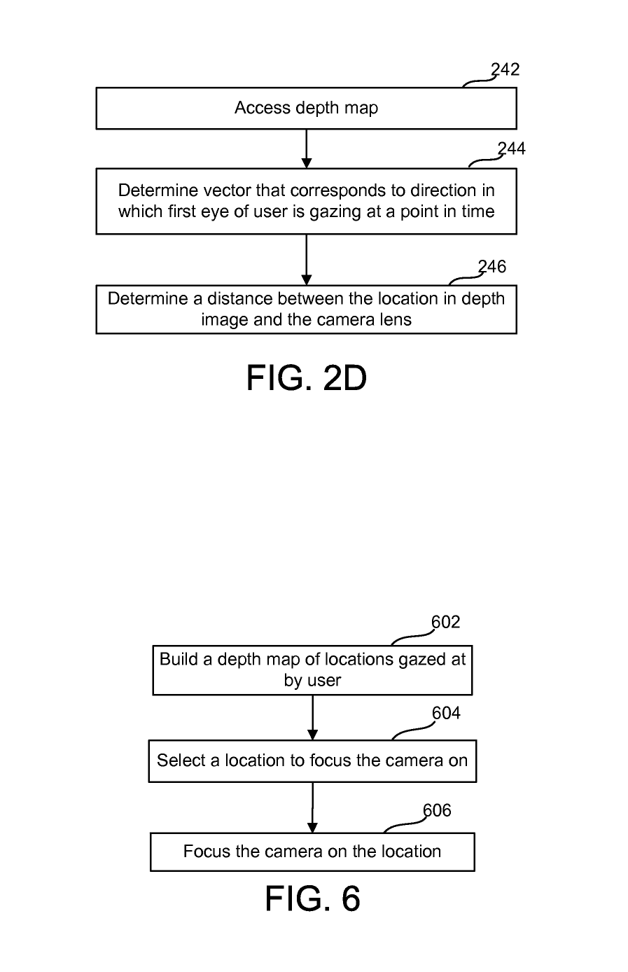

FIG. 2A is a flowchart of one embodiment of a process 200 of auto-focusing a camera. In one embodiment, the camera is part of a head mounted display (HMD). Also, the HMD has eye tracking sensors. However, the process 200 is not limited to an HMD. An example HMD is discussed below. The process could be used in systems in which the camera is in a different device than the eye tracking sensors. For example, the camera could be in a cellular telephone and the eye tracking could be performed in an HMD.

In one embodiment, steps of process 200 are performed by a processor that executes computer executable instructions. Process 200 could be performed by other logic such as an Application Specific Circuit (ASIC). Some steps could be performed by a processor, while others are performed in hardware.

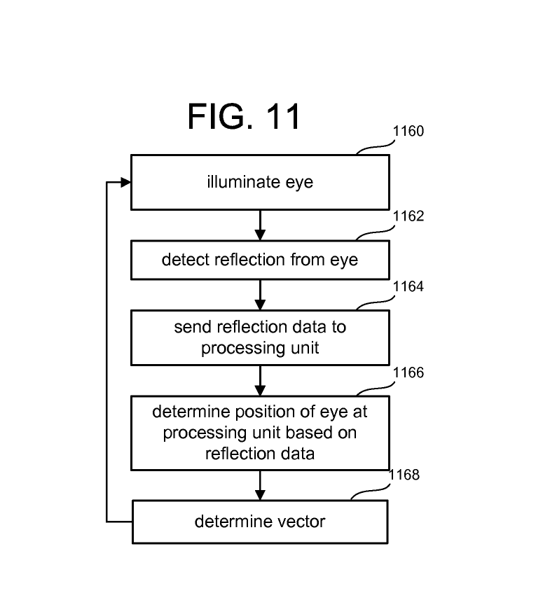

Step 202 is to track an eye gaze of a user using an eye tracking system. FIG. 11 provides one example of tracking an eye gaze of a user. In one embodiment, an HMD has an eye tracking system that is used in step 201.

In step 204, one or more vectors are determined that corresponds to a direction in which an eye (or eyes) of the user is gazing at a point in time based on tracking the eye gaze. The direction is in a field of view of a camera that is to be focused.

In step 206, a focusing distance is determined based on the vector(s) and a location of a lens of the camera. In one embodiment, an intersection of two eye vectors are used to determine the distance. In one embodiment, the distance can be determined by accessing a depth image, knowing a physical relationship between the camera and the depth image, and determining some point in the depth image based on at least one eye tracking vector.

In step 208, the camera lens is focused based on the focusing distance.

In one embodiment, two eye vectors are used in the process of FIG. 2A. FIGS. 2B and 2C will be used to illustrate one embodiment in which two eye vectors are used.

Steps 222 and 224, in general determine vectors that correspond to the direction that the user's right and left eye are gazing. As noted, gazing refers to the user looking in some direction for some defined time. The time can be any length. Steps 222 and 224224 may be performed in response to determining that the user's gaze has been fixed for the defined time. For example, an eye tracking system can continuously monitor the user's eyes, such that each time that the user's gaze is fixed for some minimum time, an eye vector is determined for each eye.

In step 222, a first vector is determined that corresponds to a first direction in which a first eye of a user is gazing at a point in time. More precisely, the user is gazing in this direction for some time period, but for the sake of discussion this time period includes a reference point in time.

In step 224, a second vector is determined that corresponds to a second direction in which a second eye of the user is gazing at the point in time.

Steps 222 and 224 may be performed by the eye tracking of the HMD. Thus, the first and second vector can be determined based on the eye tracking step 202. Steps 222 and 224 can be performed at any time. In one embodiment, they are performed in response to the system receiving a request to focus the camera lens. This could be a request to take a photograph (e.g., still image) or a request to captured video (e.g., moving images). However, these steps 222-224 could be performed without any request to focus the camera. Thus, the location at which the user is gazing can already be determined prior to a request to focus the camera 113.

In step 226, a location of an intersection of the first vector and the second vector is determined. This location may provide a distance between the user and the point at which the user is gazing. Typically this location is somewhere in the field of view of the camera 113. If it is determined that the gaze point is not in the field of view of the camera 113, the gaze point could be disregarded.

FIG. 2C is a diagram to help illustrate principles of one embodiment. FIG. 2B shows an example that shows two eyes 140a, 140b of a user 13, as well as vectors that represent the direction of eye gaze. The FIG. 2C shows an x-z perspective with respect to the examples in FIGS. 1A and 1B. Thus, FIG. 2C shows a perspective from the top looking down with respect to FIGS. 1A and 1B.

FIG. 2C shows a first vector from the first eye 140a and a second vector from the second eye 140b. FIG. 2C only shows the x-z aspect of these two vectors. The first and second vectors typically have a y-aspect as well. Referring back to FIG. 1A, the dotted line represents the x-y aspect of one of the vectors. The vectors may be determined in steps 222 and 214, respectively.

A point of intersection of the two vectors is also shown. Sometimes the first and second vectors will not precisely intersect at a 3D point. This may be due to limitations in the ability to precisely track the eye gaze, or perhaps a characteristic of the way in which the user is gazing. As one example, the two vectors may intersect as depicted in FIG. 2C when considering only the x-z coordinates. However, at the depicted location of intersection, the two vectors might have different y-coordinates.

In such a case, the system could define the location of intersection based on the crossing when considering only the z-x coordinates. Any difference in y-coordinates might be averaged, as one example. Thus, as defined herein, the term “location of an intersection” or the like when used to refer to the two eye vectors does not require that the two vectors share the exact some point in 3D space. In other words, location of intersection could be determined based on two of the three coordinates. However, the third coordinate is considered when defining the location of intersection. Other techniques could be used to determine and define the location of intersection.

In one embodiment, the location of intersection is defined as a point in a 3D coordinate system. This could be any 3D coordinate system having an origin anywhere. The 3D coordinate system could be Cartesian (e.g., x, y, z), polar, etc. The origin could be fixed in the environment in which the user and camera are located or could be fixed with respect to some point that may move in the environment. For example, the origin could be some point on an HMD, the user, a camera, etc.

In step 228, a distance (e.g., D1 in FIG. 2C) is determined between the location of intersection and a location of a lens 213 (or other element such as sensor 214) of the camera 113. This distance can be used to focus the camera 113. FIG. 2C shows one example of calculating this distance, D1. In one embodiment, the system determines a 3D coordinate of the lens 213 (or other element) of the camera 113.

In one embodiment, the relative location of the camera lens 213 to the person's eyes 140 is used in order to make the calculation. In one embodiment, there is some common coordinate system between the user's eyes 140 and the camera 113. The device 2 knows the location of the camera 113 and the user's eyes 140 in this common coordinate system, such that D1 can be accurately determined.

After step 228, step 210 from FIG. 2A may be performed. In step 210, the lens 213 is focused based on the distance, D1. Focusing the lens 213 refers to modifying the optics of the camera 113 such that the lens 213 is properly focuses at the sensor 214, in one embodiment. Numerous ways of focusing the lens 213 based on the distance are described herein. In FIG. 2C, the light received by the lens 213 is focused onto a photoreceptor such as a CMOS sensor. Other sensors 214 may be used.

In one embodiment, the lens is focused based on at least one vector from eye tracking and depth values from a depth image. FIG. 2D is a flowchart of one embodiment that uses a depth image and at least one vector. In step 242, a depth image is accessed. The depth image contains depth values, in one embodiment. The depth image may contain an array of depth values. The depth values may be z-values from some point of origin, such as a depth camera. However, the z-values could be converted to some other point of origin. The depth image can be determined in any manner.

In step 244, at least one vector is determined based on the eye tracking (of, for example, step 202).

In step 246, the system determines a focusing distance for the camera based on depth values in the depth image and the vector. In one embodiment, the system generates 3D model of the environment from the depth image. This 3D model could be from a point of view of any coordinate system. Suitable transformation of coordinate systems may be made if the vector or location of camera to be focused are in other coordinate systems. The 3D model could be a point-cloud model, but that is not a requirement. The system may determine an intersection between the vector and the 3D model, as one way of determining an object that the user is focused on. Other techniques could be used.

The system knows the location of the camera relative to the position of a depth camera used to capture the depth image, in one embodiment. Thus, if the system determines an object associated with the depth image that corresponds to the vector (e.g., an object that the vector intersects), and the system has a 3D coordinate for the object, the system can determine the distance from the camera to the object. This distance may be used for the focusing distance.

One possible application of auto-focusing is used in conjunction with a near-eye see through display having a front facing camera and one or more sensors for tracking eye gaze. A near-eye see through display may be implemented as a head mounted display (HMD). Although embodiments are not limited to an HMD, an example HMD will be discussed as one possible use case.

Head-mounted display (HMD) devices can be used in various applications, including military, aviation, medicine, video gaming, entertainment, sports, and so forth. See-through HMD devices allow the user to observe the physical world, while optical elements add light from one or more small micro-displays into the user's visual path, to provide an augmented reality image.

See-through HMD devices can use optical elements such as mirrors, prisms, and holographic lenses to add light from one or two small micro-displays into a user's visual path. The light provides holographic images to the user's eyes via see-though lenses.

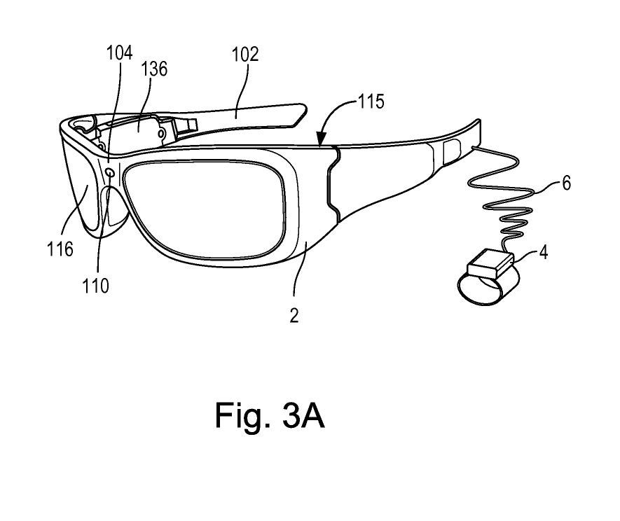

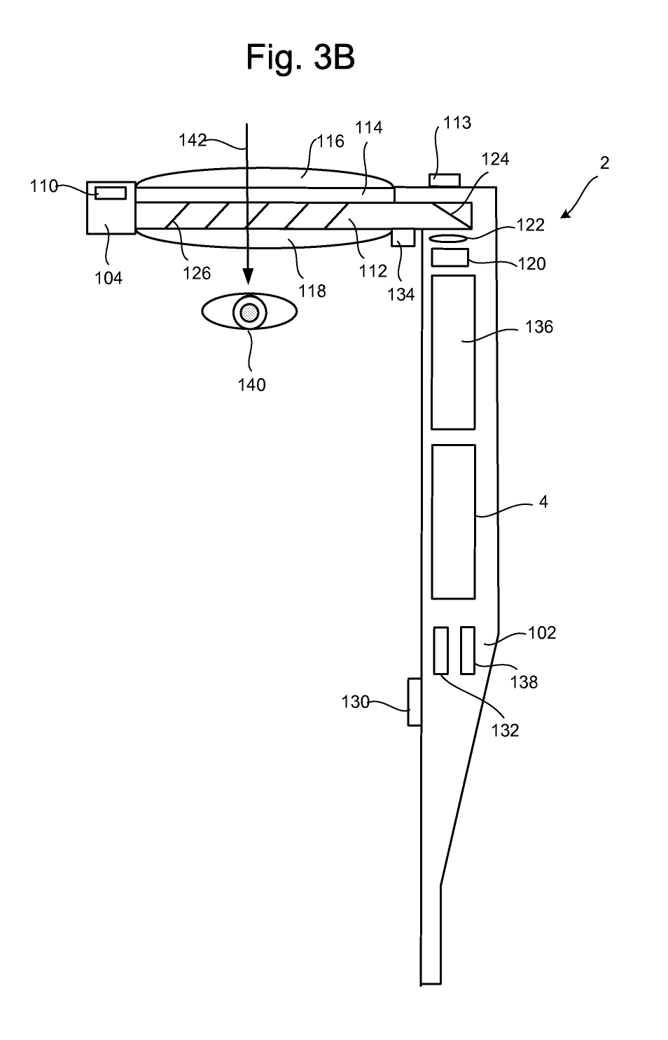

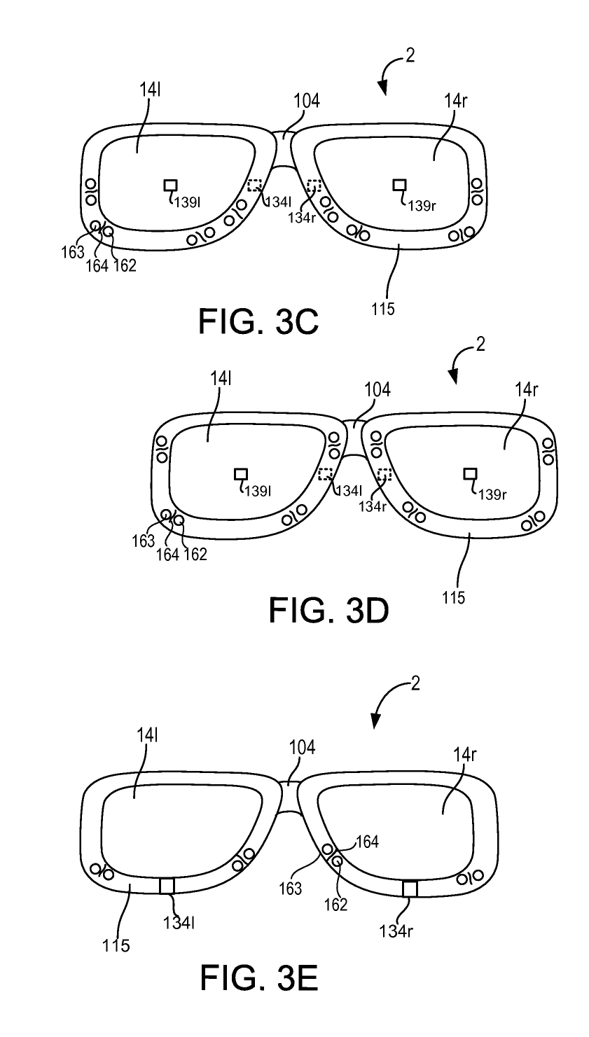

FIG. 3A is a block diagram depicting example components of one embodiment of a HMD device. The HMD device 2 includes a head-mounted frame 115 which can be generally in the shape of an eyeglass frame, and include a temple 102, and a front lens frame including a nose bridge 104. Built into nose bridge 104 is a microphone 110 for recording sounds and transmitting that audio data to processing unit 4. Lens 116 is a see-through lens.

The HMD device can be worn on the head of a user so that the user can see through a display and thereby see a real-world scene which includes an image which is not generated by the HMD device. The HMD device 2 can be self-contained so that all of its components are carried by, e.g., physically supported by, the frame 115. Optionally, one or more component of the HMD device is not carried by the frame. For example, one of more components which are not carried by the frame can be physically attached by a wire to a component carried by the frame. Further, one of more components which are not carried by the frame can be in wireless communication with a component carried by the frame, and not physically attached by a wire or otherwise to a component carried by the frame. The one or more components which are not carried by the frame can be carried by the user, in one approach, such as on the wrist. The processing unit 4 could be connected to a component in the frame via a wire or via a wireless link. The term “HMD device” can encompass both on-frame and off-frame components.

The processing unit 4 includes much of the computing power used to operate HMD device 2. The processor may execute instructions stored on a processor readable storage device for performing the processes described herein. In one embodiment, the processing unit 4 communicates wirelessly (e.g., using Wi-Fi®, BLUETOOTH®, infrared (e.g., IrDA® or INFRARED DATA ASSOCIATION® standard), or other wireless communication means) to one or more hub computing systems.

Control circuits 136 provide various electronics that support the other components of HMD device 2.

FIG. 3B depicts a top view of a portion of HMD device 2, including a portion of the frame that includes temple 102 and nose bridge 104. Only the right side of HMD device 2 is depicted. At the front of HMD device 2 is a forward- or room-facing video camera 113 that can capture video and still images. Those images are transmitted to processing unit 4, as described below. The forward-facing camera 113 faces outward and has a viewpoint similar to that of the user. The forward-facing camera 113 could be a video camera, still image camera, or capable of capturing both still images and video. In one embodiment, the forward-facing video camera 113 is focused based on tracking the user's eye gaze.

A portion of the frame of HMD device 2 surrounds a display that includes one or more lenses. To show the components of HMD device 2, a portion of the frame surrounding the display is not depicted. The display includes a light guide optical element 112, opacity filter 114, see-through lens 116 and see-through lens 118. In one embodiment, opacity filter 114 is behind and aligned with see-through lens 116, light guide optical element 112 is behind and aligned with opacity filter 114, and see-through lens 118 is behind and aligned with light guide optical element 112. See-through lenses 116 and 118 are standard lenses used in eye glasses and can be made to any prescription (including no prescription). In one embodiment, see-through lenses 116 and 118 can be replaced by a variable prescription lens. In some embodiments, HMD device 2 will include only one see-through lens or no see-through lenses. In another alternative, a prescription lens can go inside light guide optical element 112. Opacity filter 114 filters out natural light (either on a per pixel basis or uniformly) to enhance the contrast of the augmented reality imagery. Light guide optical element 112 channels artificial light to the eye.

Mounted to or inside temple 102 is an image source, which (in one embodiment) includes microdisplay 120 for projecting an augmented reality image and lens 122 for directing images from microdisplay 120 into light guide optical element 112. In one embodiment, lens 122 is a collimating lens. An augmented reality emitter can include microdisplay 120, one or more optical components such as the lens 122 and light guide 112, and associated electronics such as a driver. Such an augmented reality emitter is associated with the HMD device, and emits light to a user's eye, where the light represents augmented reality still or video images.

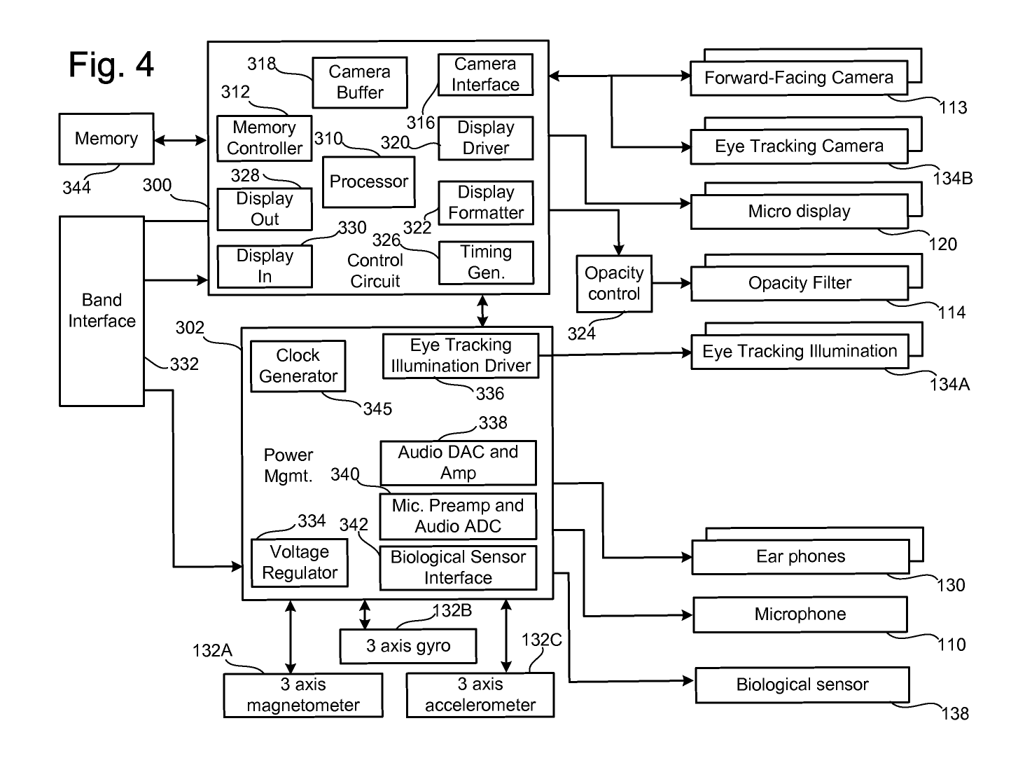

Control circuits 136 provide various electronics that support the other components of HMD device 2. More details of control circuits 136 are provided below with respect to FIG. 4. Inside, or mounted to temple 102, are ear phones 130, inertial sensors 132 and biological metric sensor 138. Other biological sensors could be provided to detect a biological metric such as body temperature, blood pressure or blood glucose level. Characteristics of the user's voice such as pitch or rate of speech can also be considered to be biological metrics. The eye tracking camera 134 can also detect a biological metric such as pupil dilation amount in one or both eyes. Heart rate could also be detected from images of the eye which are obtained from eye tracking camera 134. In one embodiment, inertial sensors 132 include a three axis magnetometer 132A, three axis gyro 132B and three axis accelerometer 132C (See FIG. 3). The inertial sensors are for sensing position, orientation, sudden accelerations of HMD device 2. For example, the inertial sensors can be one or more sensors which are used to determine an orientation and/or location of user's head.

Microdisplay 120 projects an image through lens 122. Different image generation technologies can be used. For example, with a transmissive projection technology, the light source is modulated by optically active material, and backlit with white light. These technologies are usually implemented using LCD type displays with powerful backlights and high optical energy densities. With a reflective technology, external light is reflected and modulated by an optically active material. The illumination is forward lit by either a white source or RGB source, depending on the technology. Digital light processing (DGP), liquid crystal on silicon (LCOS) and MIRASOL® (a display technology from QUALCOMM®, INC.) are all examples of reflective technologies which are efficient as most energy is reflected away from the modulated structure. With an emissive technology, light is generated by the display. For example, a PicoP™-display engine (available from MICROVISION, INC.) emits a laser signal with a micro mirror steering either onto a tiny screen that acts as a transmissive element or beamed directly into the eye.

Light guide optical element 112 transmits light from microdisplay 120 to the eye 140 of the user wearing the HMD device 2. Light guide optical element 112 also allows light from in front of the HMD device 2 to be transmitted through light guide optical element 112 to eye 140, as depicted by arrow 142, thereby allowing the user to have an actual direct view of the space in front of HMD device 2, in addition to receiving an augmented reality image from microdisplay 120. Thus, the walls of light guide optical element 112 are see-through. Light guide optical element 112 includes a first reflecting surface 124 (e.g., a mirror or other surface). Light from microdisplay 120 passes through lens 122 and is incident on reflecting surface 124. The reflecting surface 124 reflects the incident light from the microdisplay 120 such that light is trapped inside a planar, substrate comprising light guide optical element 112 by internal reflection. After several reflections off the surfaces of the substrate, the trapped light waves reach an array of selectively reflecting surfaces, including example surface 126.

Reflecting surfaces 126 couple the light waves incident upon those reflecting surfaces out of the substrate into the eye 140 of the user. As different light rays will travel and bounce off the inside of the substrate at different angles, the different rays will hit the various reflecting surface 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light guide optical element can be found in U.S. Patent Application Publication 2008/0285140, published on Nov. 20, 2008, incorporated herein by reference in its entirety. In one embodiment, each eye will have its own light guide optical element 112. When the HMD device has two light guide optical elements, each eye can have its own microdisplay 120 that can display the same image in both eyes or different images in the two eyes. In another embodiment, there can be one light guide optical element which reflects light into both eyes.

Opacity filter 114, which is aligned with light guide optical element 112, selectively blocks natural light, either uniformly or on a per-pixel basis, from passing through light guide optical element 112. In one embodiment, the opacity filter can be a see-through LCD panel, electrochromic film, or similar device. A see-through LCD panel can be obtained by removing various layers of substrate, backlight and diffusers from a conventional LCD. The LCD panel can include one or more light-transmissive LCD chips which allow light to pass through the liquid crystal. Such chips are used in LCD projectors, for instance.

Opacity filter 114 can include a dense grid of pixels, where the light transmissivity of each pixel is individually controllable between minimum and maximum transmissivities. A transmissivity can be set for each pixel by the opacity filter control circuit 224, described below. More details of an opacity filter are provided in U.S. patent application Ser. No. 12/887,426, “Opacity Filter For See-Through Mounted Display,” filed on Sep. 21, 2010, incorporated herein by reference in its entirety.

In one embodiment, the display and the opacity filter are rendered simultaneously and are calibrated to a user's precise position in space to compensate for angle-offset issues. Eye tracking (e.g., using eye tracking camera 134) can be employed to compute the correct image offset at the extremities of the viewing field. Eye tracking can also be used to provide data for focusing the front facing camera 113, or another camera. The eye tracking camera 134 and other logic to compute eye vectors are considered to be an eye tracking system, in one embodiment.

FIG. 3C illustrates an exemplary arrangement of positions of respective sets of gaze detection elements in a HMD 2 embodied in a set of eyeglasses. What appears as a lens for each eye represents a display optical system 14 for each eye, e.g. 14r and 14l. A display optical system includes a see-through lens, as in an ordinary pair of glasses, but also contains optical elements (e.g. mirrors, filters) for seamlessly fusing virtual content with the actual and direct real world view seen through the lens 6. A display optical system 14 has an optical axis which is generally in the center of the see-through lens in which light is generally collimated to provide a distortionless view. For example, when an eye care professional fits an ordinary pair of eyeglasses to a user's face, a goal is that the glasses sit on the user's nose at a position where each pupil is aligned with the center or optical axis of the respective lens resulting in generally collimated light reaching the user's eye for a clear or distortionless view.

In the example of FIG. 3C, a detection area 139r, 139l of at least one sensor is aligned with the optical axis of its respective display optical system 14r, 14l so that the center of the detection area 139r, 139l is capturing light along the optical axis. If the display optical system 14 is aligned with the user's pupil, each detection area 139 of the respective sensor 134 is aligned with the user's pupil. Reflected light of the detection area 139 is transferred via one or more optical elements to the actual image sensor 134 of the camera, in this example illustrated by dashed line as being inside the frame 115.

In one example, a visible light camera also commonly referred to as an RGB camera may be the sensor, and an example of an optical element or light directing element is a visible light reflecting mirror which is partially transmissive and partially reflective. The visible light camera provides image data of the pupil of the user's eye, while IR photodetectors 162 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In one embodiment, the at least one sensor 134 is an IR camera or a position sensitive detector (PSD) to which IR radiation may be directed. For example, a hot reflecting surface may transmit visible light but reflect IR radiation. The IR radiation reflected from the eye may be from incident radiation of the illuminators 153, other IR illuminators (not shown) or from ambient IR radiation reflected off the eye. In some examples, sensor 134 may be a combination of an RGB and an IR camera, and the optical light directing elements may include a visible light reflecting or diverting element and an IR radiation reflecting or diverting element. In some examples, a camera may be small, e.g. 2 millimeters (mm) by 2 mm. An example of such a camera sensor is the Omnivision OV7727. In other examples, the camera may be small enough, e.g. the Omnivision OV7727, e.g. that the image sensor or camera 134 may be centered on the optical axis or other location of the display optical system 14. For example, the camera 134 may be embedded within a lens of the system 14. Additionally, an image filtering technique may be applied to blend the camera into a user field of view to lessen any distraction to the user.

In the example of FIG. 3C, there are four sets of an illuminator 163 paired with a photodetector 162 and separated by a barrier 164 to avoid interference between the incident light generated by the illuminator 163 and the reflected light received at the photodetector 162. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength. Infra-red may also include near-infrared. As there can be wavelength drift of an illuminator or photodetector or a small range about a wavelength may be acceptable, the illuminator and photodetector may have a tolerance range about a wavelength for generation and detection. In embodiments where the sensor is an IR camera or IR position sensitive detector (PSD), the photodetectors may be additional data capture devices and may also be used to monitor the operation of the illuminators, e.g. wavelength drift, beam width changes, etc. The photodetectors may also provide glint data with a visible light camera as the sensor 134.

As mentioned above, in some embodiments which calculate a cornea center as part of determining a gaze vector, two glints, and therefore two illuminators will suffice. However, other embodiments may use additional glints in determining a pupil position and hence a gaze vector. As eye data representing the glints is repeatedly captured, for example at 30 frames a second or greater, data for one glint may be blocked by an eyelid or even an eyelash, but data may be gathered by a glint generated by another illuminator.

FIG. 3D illustrates another exemplary arrangement of positions of respective sets of gaze detection elements in a set of eyeglasses. In this embodiment, two sets of illuminator 163 and photodetector 162 pairs are positioned near the top of each frame portion 115 surrounding a display optical system 14, and another two sets of illuminator and photodetector pairs are positioned near the bottom of each frame portion 115 for illustrating another example of a geometrical relationship between illuminators and hence the glints they generate. This arrangement of glints may provide more information on a pupil position in the vertical direction.

FIG. 3E illustrates yet another exemplary arrangement of positions of respective sets of gaze detection elements. In this example, the sensor 134r, 1341 is in line or aligned with the optical axis of its respective display optical system 14r, 14l but located on the frame 115 below the system 14. Additionally, in some embodiments, the camera 134 may be a depth camera or include a depth sensor. A depth camera may be used to track the eye in 3D. In this example, there are two sets of illuminators 153 and photodetectors 152.

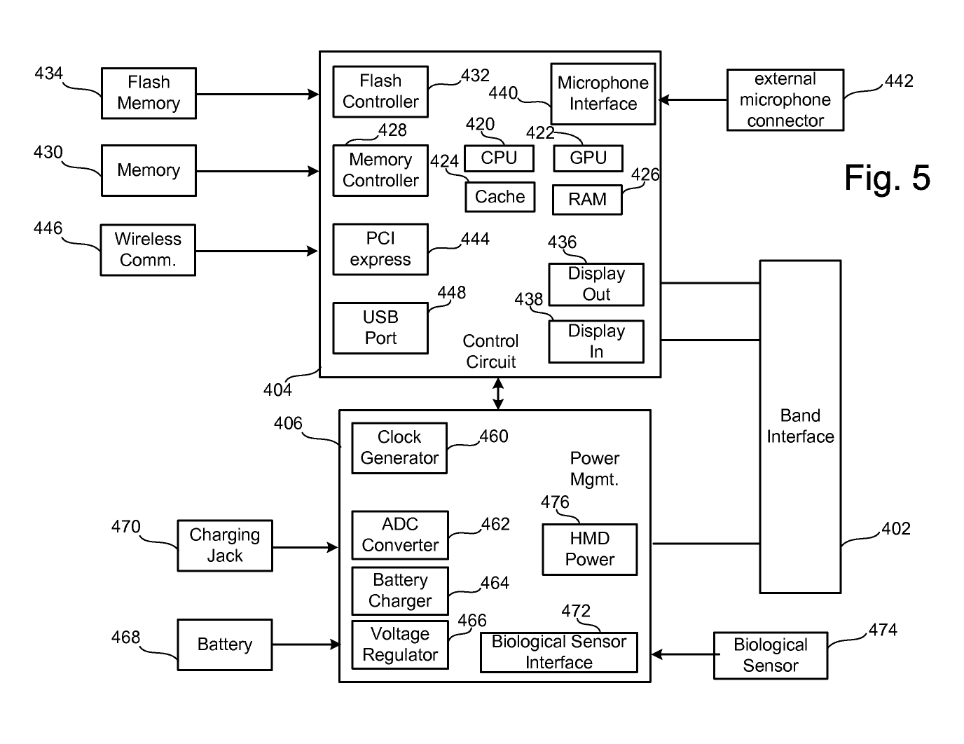

FIG. 4 is a block diagram depicting the various components of HMD device 2. FIG. 5 is a block diagram describing the various components of processing unit 4. The HMD device components include many sensors that track various conditions. The HMD device will receive instructions about an image (e.g., holographic image) from processing unit 4 and will provide the sensor information back to processing unit 4. Processing unit 4, the components of which are depicted in FIG. 4, will receive the sensory information of the HMD device 2. Optionally, the processing unit 4 also receives sensory information from another computing device. Based on that information, processing unit 4 will determine where and when to provide an augmented reality image to the user and send instructions accordingly to the HMD device of FIG. 4.

Note that some of the components of FIG. 4 (e.g., forward facing camera 113, eye tracking camera 134B, microdisplay 120, opacity filter 114, eye tracking illumination 134A and earphones 130) are shown in shadow to indicate that there may be two of each of those devices, one for the left side and one for the right side of HMD device. Regarding the forward-facing camera 113, in one approach, one camera is used to obtain images using visible light.

In another approach, two or more cameras with a known spacing between them are used as a depth camera to also obtain depth data for objects in a room, indicating the distance from the cameras/HMD device to the object.

FIG. 4 shows the control circuit 300 in communication with the power management circuit 302. Control circuit 300 includes processor 310, memory controller 312 in communication with memory 344 (e.g., DRAM), camera interface 316, camera buffer 318, display driver 320, display formatter 322, timing generator 326, display out interface 328, and display in interface 330. In one embodiment, all of components of control circuit 300 are in communication with each other via dedicated lines or one or more buses. In another embodiment, each of the components of control circuit 300 is in communication with processor 310. Camera interface 316 provides an interface to the two forward facing cameras 113 and stores images received from the forward facing cameras in camera buffer 318. Display driver 320 drives microdisplay 120. Display formatter 322 provides information, about the augmented reality image being displayed on microdisplay 120, to opacity control circuit 324, which controls opacity filter 114. Timing generator 326 is used to provide timing data for the system. Display out interface 328 is a buffer for providing images from forward facing cameras 112 to the processing unit 4. Display in interface 330 is a buffer for receiving images such as an augmented reality image to be displayed on microdisplay 120.

Display out interface 328 and display in interface 330 communicate with band interface 332 which is an interface to processing unit 4, when the processing unit is attached to the frame of the HMD device by a wire, or communicates by a wireless link, and is worn on the wrist of the user on a wrist band. This approach reduces the weight of the frame-carried components of the HMD device. In other approaches, as mentioned, the processing unit can be carried by the frame and a band interface is not used.

Power management circuit 302 includes voltage regulator 334, eye tracking illumination driver 336, audio DAC and amplifier 338, microphone preamplifier audio ADC 340, biological sensor interface 342 and clock generator 345. Voltage regulator 334 receives power from processing unit 4 via band interface 332 and provides that power to the other components of HMD device 2. Eye tracking illumination driver 336 provides the infrared (IR) light source for eye tracking illumination 134A, as described above. Audio DAC and amplifier 338 receives the audio information from earphones 130. Microphone preamplifier and audio ADC 340 provides an interface for microphone 110. Biological sensor interface 342 is an interface for biological sensor 138. Power management unit 302 also provides power and receives data back from three-axis magnetometer 132A, three-axis gyroscope 132B and three axis accelerometer 132C.

FIG. 5 is a block diagram describing the various components of processing unit 4. Control circuit 404 is in communication with power management circuit 406. Control circuit 404 includes a central processing unit (CPU) 420, graphics processing unit (GPU) 422, cache 424, RAM 426, memory control 428 in communication with memory 430 (e.g., DRAM), flash memory controller 432 in communication with flash memory 434 (or other type of non-volatile storage), display out buffer 436 in communication with HMD device 2 via band interface 402 and band interface 332 (when used), display in buffer 438 in communication with HMD device 2 via band interface 402 and band interface 332 (when used), microphone interface 440 in communication with an external microphone connector 442 for connecting to a microphone, Peripheral Component Interconnect (PCI) express interface 444 for connecting to a wireless communication device 446, and USB port(s) 448.

In one embodiment, wireless communication component 446 can include a Wi-Fi® enabled communication device, BLUETOOTH®communication device, infrared communication device, etc. The wireless communication component 446 is a wireless communication interface which, in one implementation, receives data in synchronism with the content displayed by the audiovisual device 16. Further, augmented reality images may be displayed in response to the received data. In one approach, such data is received from the hub computing system 12.

The USB port can be used to dock the processing unit 4 to hub computing device 12 to load data or software onto processing unit 4, as well as charge processing unit 4. In one embodiment, CPU 420 and GPU 422 are the main workhorses for determining where, when and how to insert images into the view of the user. More details are provided below.

Power management circuit 406 includes clock generator 460, analog to digital converter 462, battery charger 464, voltage regulator 466, HMD power source 476, and biological sensor interface 472 in communication with biological sensor 474. Analog to digital converter 462 is connected to a charging jack 470 for receiving an AC supply and creating a DC supply for the system. Voltage regulator 466 is in communication with battery 468 for supplying power to the system. Battery charger 464 is used to charge battery 468 (via voltage regulator 466) upon receiving power from charging jack 470. HMD power source 476 provides power to the HMD device 2.

The calculations that determine where, how and when to insert an image may be performed by the HMD device 2.

In one embodiment, the system generates a depth map of locations at which the user gazed. Then, the camera 113 is focused based on one or more of the locations in the depth map. FIG. 6 is a flowchart of one embodiment of a process of focusing a camera based on a depth map of locations gazed at by a user. The process could be performed by an HMD, but that is not a requirement. FIG. 6 is one embodiment of process 200 of FIG. 2A.

In step 602, a depth map of locations gazed at by the user is constructed. In one embodiment, the locations are determined by tracking eye gaze. When a user moves their eyes, they may tend to hold their gaze on objects that are more interesting. The system can take note when the user gazes for some minimum time. The amount of time is a parameter that can be adjusted. For example, the system can take note when the user holds their gaze for 1 second, some pre-defined time that is less than one second, a few seconds, or some other time period.

In one embodiment, the depth map includes a 3D coordinate for each location at which the user gazed. As noted, gazed is defined as the user looking at for some defined time.

The depth map can be generated by the processes of FIG. 2A, 2B or 2D, as three examples. In one embodiment, the depth map is generated based on the intersection of two eye vectors. In one embodiment, the depth map is generated based on a depth map and at least one eye vector.

In step 604, a point or location to focus the camera 113 at is selected. This point could be one of the locations at which that user gazed. However, the point is not required to be one the locations. For example, if the user looked at two different locations (at two different distances from the camera 113), the location could be somewhere between the two locations.

Numerous ways to select the point are discussed herein. Some are based on the automatically selecting some location without the guidance of the depth map. For example, a camera 113 may be able to detect faces, such that a face is selected to focus upon. Then, the depth map may be consulted to help supplement that technique. Some embodiments select the point based on how long the user spent gazing at the various locations. Some embodiments select the point based on when the user gazed at the various locations.

In step 606, the camera 113 is focused based on the selected location.

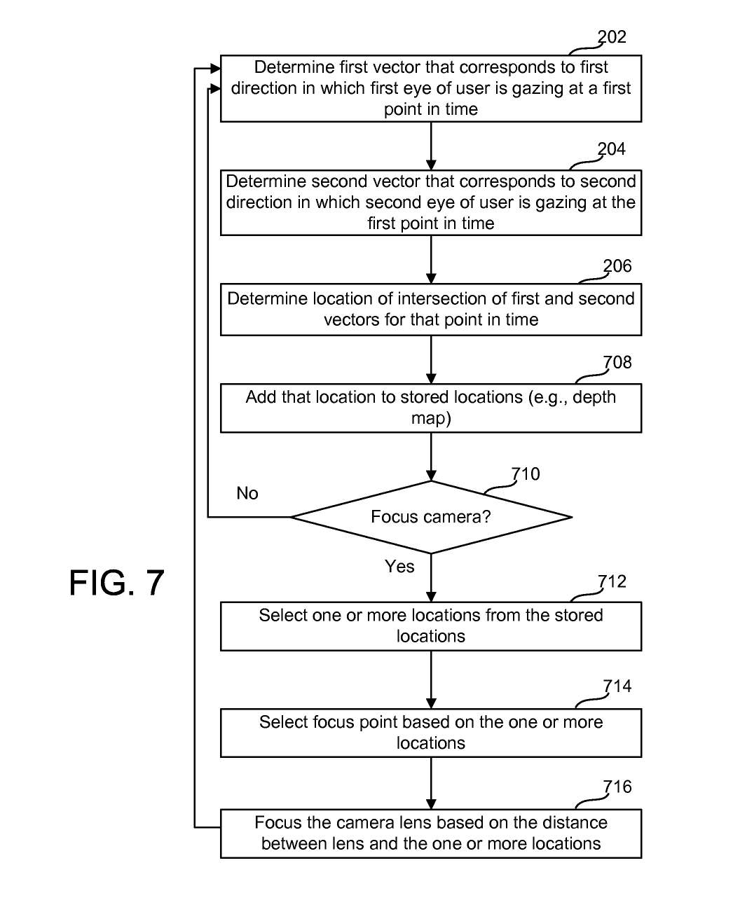

FIG. 7 is a flowchart of one embodiment of a process for automatically focusing a camera. FIG. 7 provides further details of one embodiment of FIG. 6. FIG. 7 is one embodiment of process 200 of FIG. 2A. The process begins with steps 202-206, which are similar to those of FIG. 2A. In FIG. 7, the focus point is selected based on a depth map that is created. In FIG. 7, the crude depth map is created using a technique that looks for the intersection of two eye vectors. In another embodiment, the crude depth map is created using a depth map and at least one eye vector. Thus, FIG. 7 could be modified based on the process of FIG. 2D. In step 708, the location at which the user is gazing is added to stored locations. In one embodiment, a crude depth map is constructed. The depth map contains a 3D location for each location at which the user is gazing, in one embodiment. If the camera 113 is not to be focused at this time, the process returns to step 202 such that another point at which the user is gazing is added to the depth map. Together, steps 202, 204, 206, and 708 are one embodiment of step 602 from FIG. 6 (building a depth map of locations gazed at by user).

If the system determines that the camera is to be focused (step 710=yes), then control passes to step 712. The determination of when to focus the camera can be made in a variety of ways. In one embodiment, the system more or less continuously focuses the camera 113. For example, each time that the system stores a new location (e.g., adds a new location to the depth map), the system can focus the camera 113. In one embodiment, the system waits for input to be instructed to focus the camera 113. For example, the user 13 may provide input that a picture or video is to be captured by the camera 113.

In step 712, one or more of the stored locations (e.g., locations from the depth map) are selected. These locations will be used to determine how to focus the camera 113. As one example, an assumption is made that the user desires to focus the camera 113 on the last location at which they gazed. The amount of time the user spent gazing can be used as a factor to select the location. In some cases, more than one location is selected. It may be that the user 13 has recently looked at several objects that they desire to include in the captured image. Other examples are discussed below.

In step 714, a focus location is determined based on the one or more locations. In one embodiment, rather than determining a focus location, a metric for focusing the camera 113 is determined. An example of a metric is the average distance between the camera 113 and two or more locations. Further details are discussed below.

In step 716, the camera lens is focused based on the distance between the lens 213 (or some other camera element) and the focus location. It is not an absolute requirement that a focus location be determined That is, it is not required to determine a single 3D coordinate to focus on. Rather, the system might determine the distance to several locations and focus the camera based on an average of these distances.

As discussed in FIG. 7, the camera 113 may be focused based on the stored locations or crude depth map that was constructed based on where the user gazed. In some embodiments, the final image that is captured is an image captured directly from focusing the camera 113 in step 716. In some embodiments, after capturing the image in step 716, the camera 113 captures additional images that are focused at slightly different distances to attempt to sharpen the image.

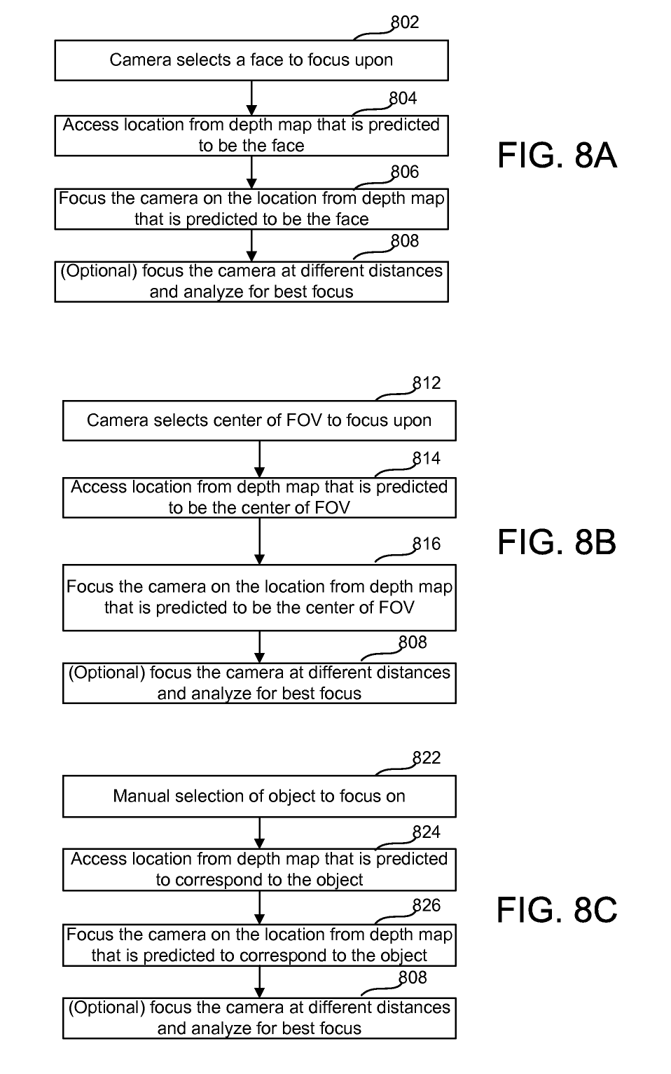

FIGS. 8A-8C are flowcharts of several embodiments in which additional images that are focused at slightly different distances could be taken to attempt to sharpen the image. However, taking the additional images is not a requirement. In FIGS. 8A-8C, several different techniques are discussed for determining what object is to be focused on. This selection can be made without reliance on eye-tracking. Once that focus location is selected, eye tracking information can be used to supplement focusing the camera 113. The eye tracking information can aid in focusing the camera 113 more rapidly than conventional techniques such as moving through various focal lengths and performing signal processing to determine what image is best in focus.

FIG. 8A is flowchart of one embodiment of a process of autofocusing a camera 113 based on eye tracking in which the camera 113 selects a face to focus upon. In step 802, the camera 113 selects a face to focus upon. Some conventional cameras have logic that is capable of detecting human faces. Some conventional cameras will assume that the user desires to focus on the face. The conventional camera may then automatically focus on the face by capturing images that are focused at different distances and determining in which image the face is focused best. However, this can be quite time consuming, especially if the camera 113 starts at a distance that is far from the correct focus point.

In step 804, a prediction of the location of the face is accessed from the depth map of locations gazed at by the user. In one embodiment, step 804 is achieved by assuming that the user last looked at the face. Therefore, the last location in the depth map is accessed as the location to focus upon, in one embodiment. As noted above, this can be a 3D coordinate. In one embodiment, step 804 is achieved by assuming that the user is intends to photograph on object that the user spent the most amount time gazing at recently. Another assumption could be made such as assuming that the closest location that the user recently gazed at corresponds to the face. Any combination of these factors, or others, may be used.

In step 806, the camera 113 is focused on the location in the depth map that is predicted to be the face. Step 806 may be achieved by determining the distance between the camera 113 and the location that was accessed from the depth map. Since this camera 113 only needs to be focused once, the image can be captured without the need for focusing at many distances. Note that steps 804-806 are one implementation of steps 712-716 of the process of FIG. 7.

One variation of the process of FIG. 8A is for step 806 to be an initial focus of a process in which the camera 113 is focused at several different distances to determine the best focus. Since the initial focus point is intelligently derived from the depth map, the focus algorithm can proceed much faster than if the camera 113 needed to repeatedly focus over a wider range of distances and analyze the captured images for focus. In optional step 808, the camera 113 is focused at different distances and analyzed for best focus.

FIG. 8B is flowchart of one embodiment of a process of autofocusing a camera 113 based on eye tracking in which the camera 113 selects the center of the camera's field of view (FOV) to focus upon. In step 812, the camera 113 or user selects the center of the camera's field of view to focus upon. Some conventional cameras would attempt to autofocus by capturing images that are focused at different distances and determining in which image the center of FOV is focused best. However, this can be quite time consuming, especially if the camera 113 starts at a distance that is far from the correct focus point.

In step 814, an estimate or prediction of the location of the center of the FOV is accessed from the depth map of locations gazed at by the user. In one embodiment, step 814 is achieved by assuming that the user last looked at something that is at the location of an object in the center of the FOV. Therefore, the last location in the depth map is accessed as the location to focus upon, in one embodiment. As noted above, this can be a 3D coordinate. In one embodiment, step 814 is achieved by assuming that the user recently spent more time looking at an object in the center of the FOV than other points. In one embodiment, step 824 is achieved by assuming that an object in the center of the FOV is the closest location that the user recently gazed at. Any combination of these factors, or others, may be used.

In step 816, the camera 113 is focused on the center of the FOV based on eye tracking data. Step 816 may be achieved by determining the distance between the camera 113 and the location that was accessed from the depth map. Since this camera 113 only needs to be focused once, the image can be captured without the need for focusing at many distances. Note that steps 814-816 are one implementation of steps 712-716 of the process of FIG. 7.

One variation of the process of FIG. 8B is for step 816 to be an initial focus of a process in which the camera 113 is focused at several different distances to determine the best focus. Since the initial focus point is intelligently derived from the depth map, the focus algorithm can proceed much faster than if the camera needed to focus over a wider range of distances. In optional step 808, the camera 113 is focused at different distances and analyzed for best focus.

FIG. 8C is flowchart of one embodiment of a process of autofocusing a camera 113 based on eye tracking in which the user manually selects an object to focus upon. In step 822, the camera 113 receives a manual selection of an object to focus on. To achieve this, a display shows the user several different possible focus points. The user then selects one of the points as the point to focus on. The user could be shown this selection in a near-eye display of an HMD. The user might be shown this in a camera's viewfinder.

In step 824, a location in the depth map that is estimated or predicted to be the manual select point is accessed. In one embodiment, step 824 is achieved by assuming that the user last looked at the manual select point. Therefore, the last location in the depth map is accessed as the location to focus upon, in one embodiment. As noted above, this can be a 3D coordinate. In one embodiment, step 824 is achieved by assuming that the user recently spent more time looking at the manual select point than other points. In one embodiment, step 824 is achieved by assuming that the manual select point is the closest location that the user recently gazed at.

In step 826, the camera 113 is focused on the manual select point based on eye tracking data. Step 826 may be achieved by determining the distance between the camera 113 and the location that was accessed from the depth map. Since this camera 113 only needs to be focused once, the image can be captured without the need for focusing at many distances. Note that steps 824-826 are one implementation of steps 712-716 of the process of FIG. 7.

One variation of the process of FIG. 8C is for step 826 to be an initial focus of a process in which the camera 113 is focused at several different distances to determine the best focus. Since the initial focus point is intelligently derived from the depth map, the focus algorithm can proceed much faster than if the camera 113 needed to focus over a wider range of distances. In optional step 808, the camera 113 is focused at different distances and analyzed for best focus.

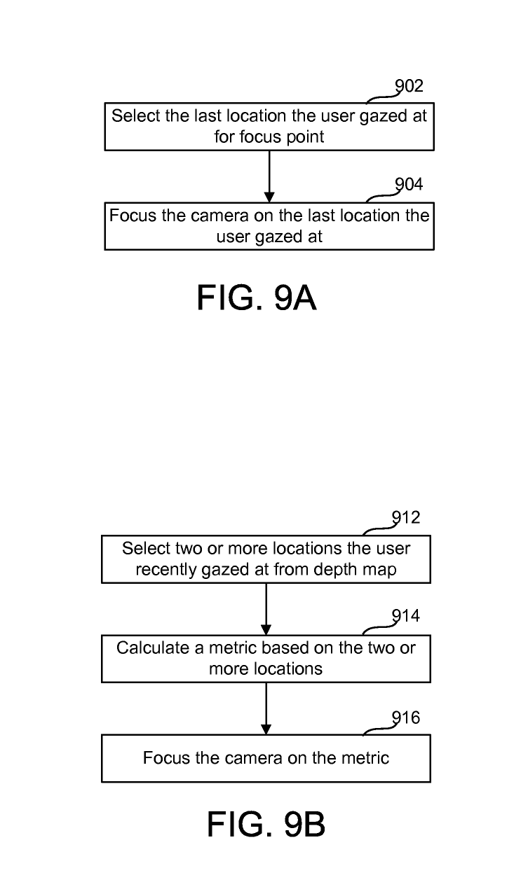

FIG. 9A is one embodiment of a flowchart of focusing a camera 113 based on the last location that a user gazed at. This process can make use of the depth map discussed above. In one embodiment, this process is used to implement steps 712-716 of the process of FIG. 7. In step 902, the last location that the user gazed at is selected as the focus point. In one embodiment, this is the location in the depth map for the most recent point in time. One variation is to require that the user spent a certain amount of time gazing at this location. Thus, the time criteria for including a location in the depth map can be shorter than the time criteria for selecting this location to focus on. One option is to exclude locations that for some reasons the user is not likely to be attempting to focus on. For example, the user may have briefly focused at some point very close to them, such as their watch. If it is determined that the point is out of a range (e.g., too close to the camera), then this point may be disregarded. Another option is to want the user that the point of focus is too close for the camera's optical system.

In step 904, the camera 113 is focused on the last location that the user gazed at, or other location selected in step 902.

FIG. 9B is one embodiment of a flowchart of focusing a camera 113 based on two or more location at which a user recently gazed. This process can make use of the depth map discussed above. In one embodiment, this process is used to implement steps 712-716 of the process of FIG. 7. An example application is if the user recently gazed at their dog and three people. This could indicate that the camera 113 should be focused on capturing such objects. Note that the system need not know what the object are. The system might only know that the user gazed at something in those directions.

In step 912, two or more locations are selected from the depth map. These locations can be selected using a variety of factors discussed herein including, but not limited to, time spent gazing at the locations, distance of the location from the user, and time since the user gazed at the location.

In step 914, a point is calculated based on the two or more locations. This point is calculated to provide the best focus to capture an object at all of the locations, in one embodiment. In one embodiment, the system calculates a metric from the two or more locations. The metric is used in step 916 to focus the camera 113. The metric might be the average distance from the lens 213, as one example. The metric might be a location that is based on the two or more locations, such as a central point.

In step 916, the camera 113 is focused based on the metric that was calculated in step 914. This can allow the camera 113 to be focused to capture two or more locations, which could be different distances from the camera 113.

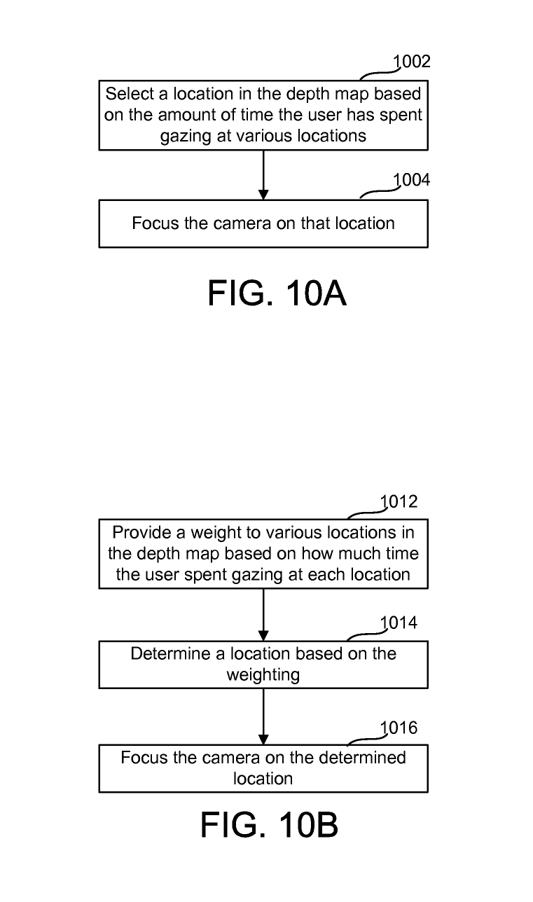

As noted above, some embodiments focus the camera 113 based on the amount of time that the user spent gazing at various locations. FIGS. 10A and 10B are two embodiments of such techniques. FIG. 10A is a flowchart of one embodiment of a process of camera autofocus based on an amount of time a user spent gazing at various locations. This process can make use of the depth map discussed above. In one embodiment, this process is used to implement steps 712-716 of the process of FIG. 7. In step 1002 of FIG. 10A, the system selects a location in the depth map based on the amount of time that the user spent gazing at various locations. In step 1004, the camera is focused for that location.

FIG. 10B is a flowchart of one embodiment of a process of camera autofocus based on weighting an amount of time a user spent gazing at various locations. This process can make use of the depth map discussed above. In one embodiment, this process is used to implement steps 712-716 of the process of FIG. 7. In step 1012 of FIG. 10B, the system provides a weight to various locations in the depth map based on the amount of time that the user spent gazing at the various locations. In step 1014, a location is determined based on that weighting. In step 1016, the camera 113 is focused based on the location determined in step 1014.

Various techniques for auto-focusing a camera 113 described herein can be combined. Some combinations have already been mentioned, but other combinations are possible.

FIG. 11 is a flowchart describing one embodiment for tracking an eye using the technology described above. In step 1160, the eye is illuminated. For example, the eye can be illuminated using infrared light from eye tracking illumination 134A. In step 1162, the reflection from the eye is detected using one or more eye tracking cameras 134B. When IR illuminators are used, typically an IR image sensor is used as well. In step 1164, the reflection data is sent from head mounted display device 2 to processing unit 4. In one embodiment, glint data is used for detecting gaze. Glint data may identify such glints from image data of the eye. Techniques other than glint data may be used. In step 1166, processing unit 4 will determine the position of the eye based on the reflection data, as discussed above. In step 1168, processing unit 4 will also determine the current vector corresponding to the direction the user's eyes are viewing based on the reflection data. The processing steps of FIG. 11 can be performed continuously during operation of the system such that the user's eyes are continuously tracked providing data for tracking the current vector.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method comprising:
tracking an eye gaze of a user using an eye tracking system;
for a plurality of points in time, determining a vector that corresponds to a direction in which an eye of the user is gazing based on tracking the eye gaze, the direction is in a field of view of a camera;
determining a distance to each of the locations based on the vector and a location of a lens of the camera, including generating a depth map that includes locations at which the user gazed for the plurality of points in time;
determining how much time the user's eves spent gazing at each of the locations in the depth map;
providing a weight to each of the locations in the depth map based on how much time the use's gazing at the respective locations;
determining a location based on the weight to each of the locations and automatically focusing the lens of the camera based on the distance to the location that was determined based on the weight.

2. The method of claim 1, wherein the determining a distance based on the vector and a location of a lens of the camera comprises:
accessing a depth image having depth values; and
determining the distance based on the depth values and the vector.

3. The method of claim 1, wherein the determining a vector that corresponds to a direction in which an eye of a user is gazing at a point in time based on tracking the eye gaze comprises:
determining a first vector that corresponds to a first direction in which a first eye of a user is gazing at a point in time based on the eye tracking;
determining a second vector that corresponds to a second direction in which a second eye of the user is gazing at the point in time based on the eye tracking, the determining a distance based on a location of a lens of the camera and the vector comprises:
determining a location of an intersection of the first vector and the second vector;
determining a distance between the location of intersection and a location of a lens of a camera.

4-6. (canceled)

7. The method of claim 1, further comprising automatically focusing the lens based on the distance comprises focusing the lens each time that a new location is stored.

8. The method of claim 1, wherein the automatically focusing the lens based on the distance comprises focusing the lens in response to receiving input to capture an image.

9. The method of claim 1, further comprising:
providing a warning that the lens is too close to the distance due to optical limitations of the camera.

10. A system comprising:
a camera having a lens;
logic coupled to the camera, the logic is configured to:
for a plurality of points in time, determine a first vector that corresponds to a first direction in which a first eye of a user is gazing;
for the plurality of points in time, determine a second vector that corresponds to a second direction in which a second eye of the user is gazing;
determine a location of intersection of the first vector and the second vector for the plurality of points in time;
store the locations at which the first vector and the second vector intersect for the plurality of points in time;
determine how much time the user's eyes spent gazing at each of the locations of intersection:
provide a weight to each of the locations of intersection based on how much time the user's eyes spent gazing at the respective locations;
determining a focus location based on the weight to each of the locations of intersection;
determine a distance between the focus location and a location of the lens; and
focus the lens based on the distance.

11-13. (canceled)

14. The system of claim 10, wherein the logic is further configured to:
select an object to focus the camera lens upon;
estimate a location from the stored locations that corresponds to the object; and
focus the lens based on the distance between the lens and the location from the stored locations that corresponds to the object.

15. The system of claim 14, wherein the logic being configured to estimate a location from the stored locations that corresponds to the object includes the logic being configured to:
access the most recent location from the stored locations that the user gazed at.

16. The system of claim 10, further comprising:
a near-eye see-through display coupled to the logic; and
one or more sensors for tracking eye gaze.

17. A method comprising:
tracking a user's eyes using an eye tracking system;
determining a plurality of first vectors that each correspond to a first direction in which a first eye of a user is gazing at different points in time based on the tracking;
determining a plurality of second vectors that each correspond to a second direction in which a second eye of the user is gazing at corresponding ones of the different points in time based on the tracking;
determining a plurality of intersections of the first vectors and the second vectors for each of the different points in time;
generating a depth map based on locations of the plurality of intersections;
providing a weight to each of the locations in the depth map based on how much time the user's eyes spent gazing at the respective locations;
determining a focus distance based on the weight to each of the locations of intersection; and
automatically focusing a lens of a camera based on the focus distance.

18. The method of claim 17, further comprising:
determining a plurality of locations in the depth map at which the user has recently gazed; and
focusing the lens based on an average distance between the lens and the locations in the depth map at which the user has recently gazed.

19. The method of claim 17, further comprising:
selecting a face to focus the camera lens upon;
predicting a location from the depth map that corresponds to the face; and
automatically focusing the lens based on the distance between the lens and the location from the depth map that corresponds to the face.

20. The method of claim 19, wherein the predicting a location from the depth map that corresponds to the face includes:
selecting a center of a field of view (FOV) to focus the camera lens upon;
predicting a location from the depth map that corresponds to the center of the field of view; and
automatically focusing the lens based on the distance between the lens and the location from the depth map that corresponds to the center of the field of view.

21. The method of claim 1, wherein the tracking an eye gaze of a user using an eye tracking system is performed by a head mounted display.

22. The method of claim 21, wherein the automatically focusing the lens of the camera based on the distance focuses a camera on the head mounted display.

23. The method of claim 19 wherein:
the predicting a location from the depth map that corresponds to the face includes assuming that the closest location that the user recently gazed at corresponds to the face; and
the automatically focusing the lens based on the distance between the lens and the location from the depth map that corresponds to the face includes using the predicted location as an initial focus of a process in which the camera lens is focused at several different distances to determine a best focus.

24. The method of claim 17, further comprising:
selecting a center of a field of view (FOV) to focus the camera lens upon;
assuming that an object in the center of the FOV is the closest location that the user recently gazed at; and
automatically focusing the lens to the distance between the lens and the location from the depth map that corresponds to the center of the field of view.

25. The method of claim 17 wherein:
the automatically focusing a lens of a camera based on the focus distance includes using the focus distance as an initial focus of a process in which the camera lens is focused at several different distances to determine a best focus.

26. The system of claim 10, wherein the focus location is a first focus location, wherein the logic is further configured to:
determine a second focus location based on time since the user gazed at each of the locations of intersection; and
focus the lens based on the second focus location.
